(19) United States
(12) Patent Application Publication
(10) Pub. No.: US 2018/0052866 A1
(43) Pub. Date: Feb. 22, 2018

(54) DEMAND BASED FILE REPLICATION

(71) Applicant: DEEPSPACE STORAGE SYSTEMS INC., Huntington Beach, CA (US)

(72) Inventor: STEPHEN CRANAGE, Colorado Springs, CO (US)

(73) Assignee: DEEPSPACE STORAGE SYSTEMS INC., Huntington Beach, CA (US)

(21) Appl. No.: 15/243,608

(22) Filed: Aug. 22, 2016

(51) Int. Cl. G06F 17/30; G06F 21/62

(52) U.S. Cl. CPC G06F 17/30174; G06F 21/6218; G06F 17/30115

(57) ABSTRACT

A method and system of data replication and distribution does not replicate the actual contents of a file to the non-local site or remote host until a user or application opens/accesses the file. However, the file does appear to be a locally resident file on the remote host. The demand-based system and methods will copy only the file metadata, or “stub” to the remote hosts. This stub provides the appearance of a local copy of the file at the remote host, but the actual contents are only conveyed if/when the file is accessed/opened at the remote host. The result is a data replication process that operates under a “just in time, just as needed” approach. The stub that is copied is comparatively very small and easily replicated with very little resources, thus saving communications bandwidth.

### BACKGROUND OF THE INVENTION

### 1. Field of the Invention

One or more embodiments of the invention relates generally to data replication solutions. More particularly, the invention relates to systems and methods of data replication and distribution where the actual contents of the file are not replicated to the non-local site until a user or application opens what appears to be a locally resident file.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Replication of data is a common problem that requires the cost of communications bandwidth to be weighed against the volume of data that needs to be replicated or distributed and the amount of time available for the distribution to take place.

Current systems lack granularity and will try to replicate everything within one location to another without regard as to whether or not the data will actually be accessed at the remote location. This process wastes resources in the process of replication files that will never be used at the alternate location.

One conventional type of file replication is remote file synchronization, or Rsync. Rsync will copy all files in a file system to another target, reflecting changes in the source file system to the target file system in near real time as they occur. This is considered a “brute force” replication process that copies the entire contents of a directory or multiple directories.

Repliweb® is a proprietary application similar to Rsync with some efficiency added to the user interface and the management of the communications channel. File transfer protocol (FTP) and secure copy protocol (SCP) are command line utilities that allow a user to copy files as needed by command line execution.

Another related technology, albeit somewhat different, is Oracle's SAMfs, now called HSM (Hierarchical Storage Manager), and Quantum's StorNext®. These systems are event based file managers but are used for data tiering (different media) and the name space is only local and the “stubs” are only available to that local system and name space. These systems do not offer data replication or data synchronization to other hosts.

Referring to FIGS. 1 and 2, an example of a conventional data replication system is shown. Data sources 12 can include a plurality of host local file systems 16 (such as host 1, host 2 and host 3, for example). To replicate this data to a remote host 10, such as from host 4 to host 1, as shown in FIG. 2, a file transfer 18 of the entire contents of the directory of local file system 16 (host 4) is performed to the local file system 14 (host 1), as exemplified in FIG. 2. It does not matter if any of the files are actually accessed or not on the remote host 10. Thus, time and communications bandwidth are used for file replication where such replication may not be needed.

In view of the foregoing, it is clear that there is a need for a system and method of data replication and distribution that improves on the current state of the art.

### SUMMARY OF THE INVENTION

Embodiments of the present invention provide a method for data replication and duplication comprising copying directory information from a file repository onto one or more local file systems, where the directory information provides an appearance on the one or more local file systems that full copies of files within the file repository are present on the one or more local file systems; and copying full contents of a requested file to a first local file system when the requested file is accessed or opened at the first local file system.

Embodiments of the present invention further provide a method for data replication and duplication comprising copying full contents of a created or modified file from a local file system to a file repository when the created or modified file is created or modified on the local file system; creating a directory information for the created or modified file onto one or more additional local file systems, where the directory information provides an appearance on the one or more additional local file systems that full copies of created or modified file is present on the one or more additional local file systems; and if the local file system modifies a file to a modified file, any full contents of the modified file which are present on any of one or more additional local file systems are reverted to include only directory information.

Embodiments of the present invention also provide a method for data replication and duplication comprising copying directory information from a file repository onto one or more local file systems, where the directory information provides an appearance on the one or more local file systems that full copies of files within the file repository are present on the one or more local file systems; copying full contents of a requested file to a first local file system when the requested file is accessed or opened at the first local file system; copying full contents of a created or modified file from one of the one or more local file systems to the file repository when the created or modified file is created or modified on the one of the one or more local file systems; creating directory information for the created or modified file onto the other ones of the one or more local file systems; and if the one of the one or more local file system modifies a file to a modified file, any full contents of the modified file which are present on any of the other ones of the one or more local file systems are reverted to include only directory information.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a data file system including data sources and remote hosts according to the prior art;

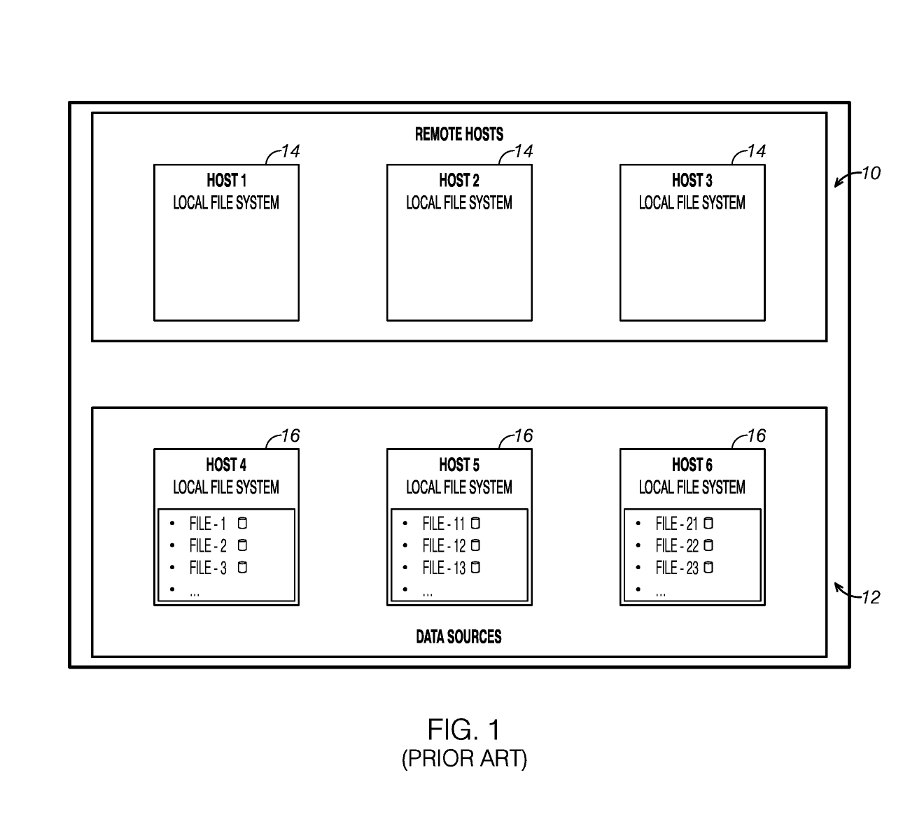

FIG. 2 illustrates the data file system of FIG. 1 showing an exemplary file transfer according to the prior art;

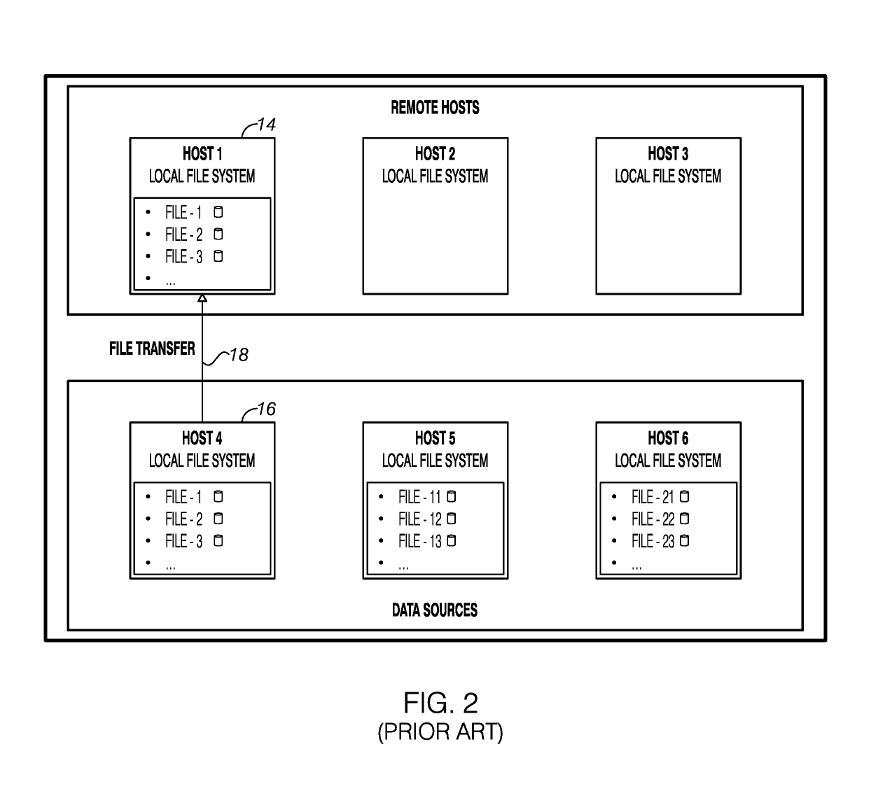

FIG. 3 illustrates a data file system including a data repository and remote hosts, each having their own name space, according to an exemplary embodiment of the present invention;

FIG. 4 illustrates a data file system showing a transfer of metadata from the data repository to the remote hosts according to an exemplary embodiment of the present invention; and

FIG. 5 illustrates a data file system showing how a file is physically copied when a user at the local file system-1 performs a “modify” or “open” command for file 1, according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Structure Query Language (SQL) Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Python, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

As used herein, the “client-side” application and “client”, such as a “database client” should be broadly construed to refer to an application, a page associated with that application, or some other resource or function invoked by a client-side request to the application. A client may operate on a computer or computing device, as defined above.

Embodiments of the present invention may include apparatuses for performing the operations disclosed herein. An apparatus may be specially constructed for the desired purposes, or it may comprise a general-purpose device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a method and system of data replication and distribution where the actual contents of a file are not replicated to the non-local site or remote host until a user or application opens the file. However, the file does appear to be a locally resident file on the remote host. The demand-based system and methods of the present invention will copy only the file metadata, or “stub” to the remote hosts. This stub provides the appearance of a local copy of the file at the remote host, but the actual contents are only conveyed if/when the file is accessed/opened at the remote host. The result is a data replication process that operates under a “just in time, just as needed” approach. The stub that is copied is comparatively very small and easily replicated with very little resources, thus saving communications bandwidth. By only replicating the remainder of the file when it is actually accessed, the replication workload can not only be restricted to the actual need (files that are opened), but the replication bandwidth can be queued based on user need for the file contents rather than an arbitrary transmission queue based on the files' alphanumeric order or location in a directory tree employed by conventional replication strategies.

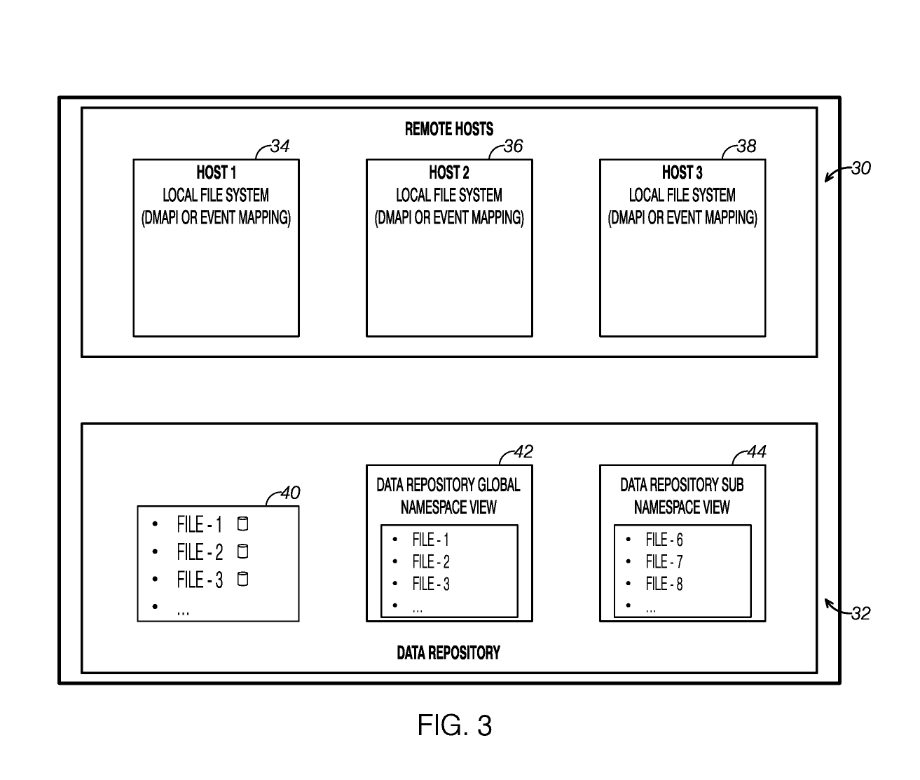

Referring to FIGS. 3 through 5, a demand based replication process can be performed as described below.

A file system includes a data repository 32 and remote hosts 30. Each host in the set of remote hosts 30 may be unique and have their own name space, as shown by Host 1, Host 2, and Host 3 (shown as elements 34, 36, and 38, respectively). The data repository 32 can include a physical file repository 40, a data repository global namespace view 42 and a data repository sub namespace view 44. Depending on permissions and mapping, each of the Hosts 34, 36, 38 of the remote host 30 can see the global 42 or sub namespace 44.

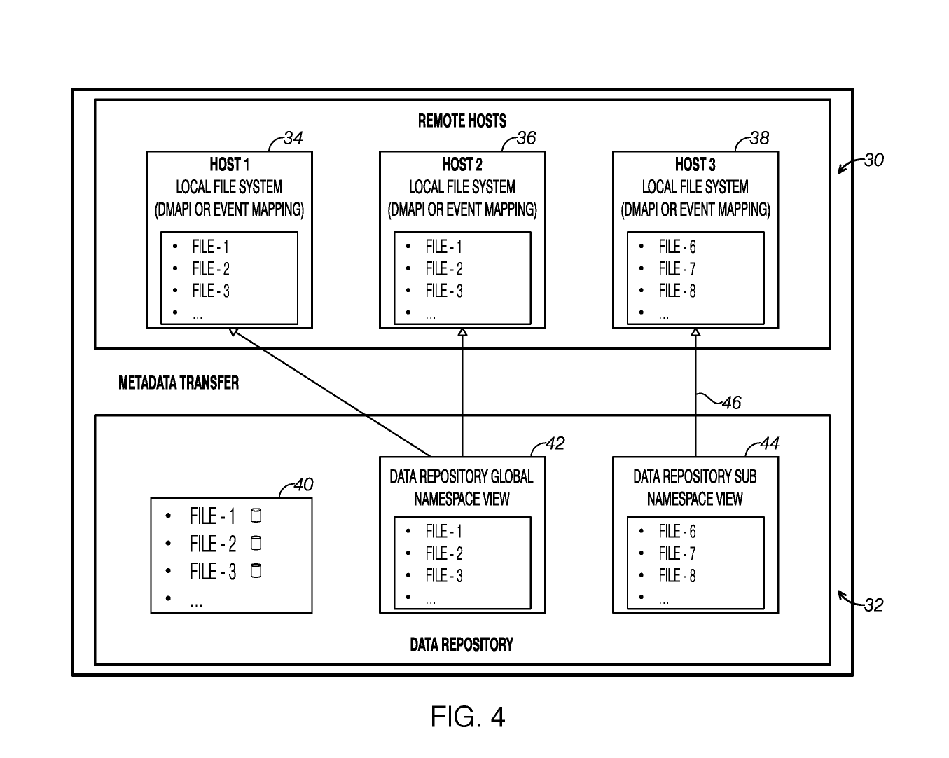

As shown in FIG. 4, each of the remote hosts 34, 36 (Host 1, Host 2) can see the contents of the data repository global namespace 42, while remote host 38 (Host 3) can see the contents of the data repository sub namespace 44. Through a metadata transfer 46, the remote hosts 34, 36, 38 each appear to have the files from the data repository global namespace 42 or the data repository sub namespace 44. However, only the metadata is replicated on each of the remote hosts 34, 36, 38.

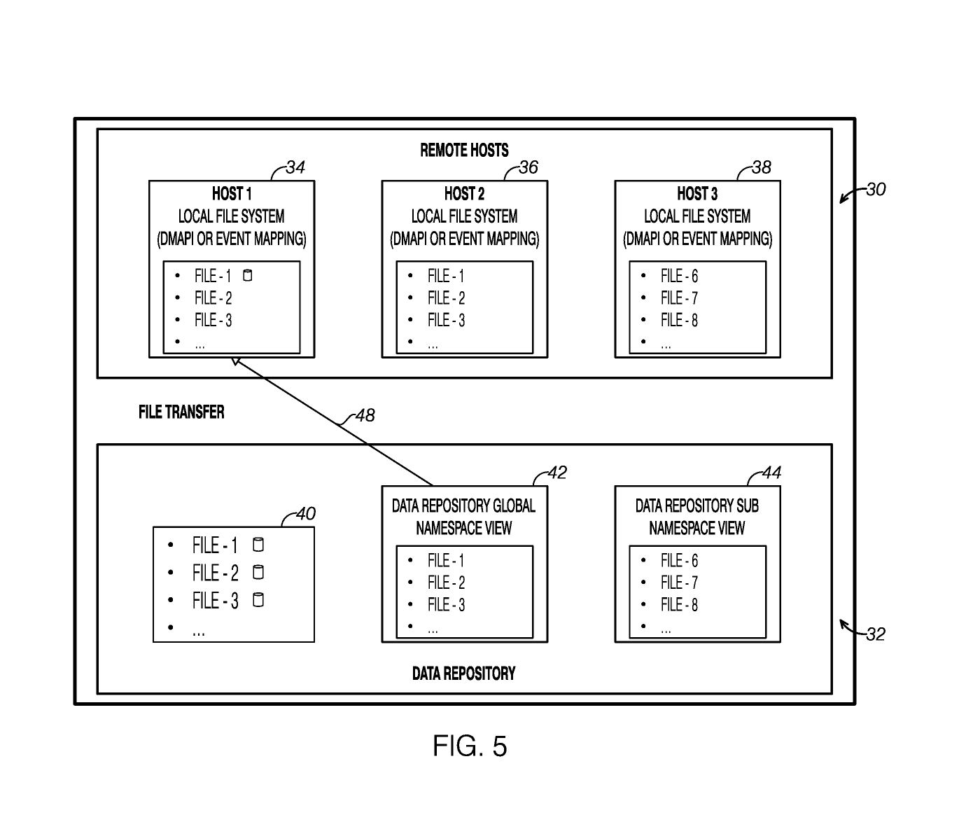

As shown in FIG. 5, when a file is requested by one of the remote hosts 34 (Host 1), via a file open or file modify command, for example, the file is then physically transferred to the remote host 34 (Host 1). If remote host 36 (Host 2) also requests to open the same file, then the file will be transferred to remote host 36 (Host 2). If, for example, remote host 36 (Host 2) modifies the file, the file will be updated in the data repository 32 and the physical file at remote host 34 (Host 1) will be invalidated, changing the file back to a stub (metadata only). In this manner, the system of the present invention can maintain synchronization of the files across multiple remote hosts 34, 36, 38.

The above can be performed on systems that have file level event notification support, such as a data management applications programming interface (DMAPI) enabled system. Below, there is provided details of the events described above for a DMAPI system.

First, a file create or modify event is captured using a supported filesystem data management API, such as DMAPI. The create/modify event instantiates the archiving or replication of the full file contents to a central repository. The create/modify event is also transmitted to the central policy engine, which examines the events and applies appropriate filters to determine what remote systems should have file metadata replicated thereto. On each instance of the replicated file, any attempt to open the file where only a stub is resident will create a DMAPI “data fault” event, causing the full file contents to be staged locally from the central repository through a DMAPI data fault handler intervention. The initial file access is merely paused during this process.

If a local copy of the file is modified, as discussed above, another “create/modify” event is passed from the DMAPI client to the central policy engine. The central policy engine filters these events and sends a message through every replicated file system's DMAPI agent to invalidate all other copies of the files, converting them into “data-less” stubs—closing the loop on the file synchronization process between all copies of the replicated files.

Aspects of the present invention can increase storage efficiencies in the realm of 90% or better by only moving data as needed to where it is needed. Prior solutions move all data identified by the user or application and do not take into account what will actually be used or accessed and its demand on time and resources cannot easily be modified for priority. In addition, the simplicity of the API utilizing current DMAPI enabled systems means that incorporating the system and methods of the present invention into existing systems would incur minimal initial costs and negate the need for complicated management file systems like Handoop File System (HDFS) and similar workflow managers currently being developed to manage large scale file movements for data analytics.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for data replication and duplication comprising:
copying directory information from a file repository onto one or more local file systems, where the directory information provides an appearance on the one or more local file systems that full copies of files within the file repository are present on the one or more local file systems; and
copying full contents of a requested file to a first local file system when the requested file is accessed or opened at the first local file system.

2. The method of claim 1, further comprising:
copying full contents of a newly created file from one of the one or more local file systems to the file repository when the newly created file is created on one of the one or more local file systems.

3. The method of claim 1, further comprising:
copying full contents of a modified file to the file repository when a file is modified on one of the one of more local file systems; and
if any full contents of the file that was modified is present on any of the other ones of the one or more local file systems, reverting these files to include only directory information.

4. The method of claim 1, wherein the directory information is independently selected from a global namespace view and a sub namespace view for each of the one or more local file systems.

5. The method of claim 4, wherein the directory information is selected based on permissions of each of the one or more local file systems.

6. A method for data replication and duplication comprising:
copying full contents of a created or modified file from a local file system to a file repository when the created or modified file is created or modified on the local file system;
creating a directory information for the created or modified file onto one or more additional local file systems, where the directory information provides an appearance on the one or more additional local file systems that full copies of created or modified file is present on the one or more additional local file systems; and
if the local file system modifies a file to a modified file, any full contents of the modified file which are present on any of one or more additional local file systems are reverted to include only directory information.

7. The method of claim 6, further comprising:
copying directory information from the file repository onto each of the one or more local file systems; and
copying full contents of a requested file to a first local file system when the requested file is accessed or opened at the first local file system.

8. The method of claim 6, wherein the directory information is independently selected from a global namespace view and a sub namespace view for each of the one or more local file systems.

9. The method of claim 8, wherein the directory information is selected based on permissions of each of the one or more local file systems.

10. A method for data replication and duplication comprising:
copying directory information from a file repository onto one or more local file systems, where the directory information provides an appearance on the one or more local file systems that full copies of files within the file repository are present on the one or more local file systems;
copying full contents of a requested file to a first local file system when the requested file is accessed or opened at the first local file system;
copying full contents of a created or modified file from one of the one or more local file systems to the file repository when the created or modified file is created or modified on the one of the one or more local file systems;
creating directory information for the created or modified file onto the other ones of the one or more local file systems; and
if the one of the one or more local file system modifies a file to a modified file, any full contents of the modified file which are present on any of the other ones of the one or more local file systems are reverted to include only directory information.

11. The method of claim 10, wherein the directory information is independently selected from a global namespace view and a sub namespace view for each of the one or more local file systems.

12. The method of claim 12, wherein the directory information is selected based on permissions of each of the one or more local file systems.
